(19) United States
(12) Patent Application Publication
(10) Pub. No.: US 2026/0248215 A1
(43) Pub. Date: Aug. 27, 2026

(54) HEATED HAND GARMENT

(71) Applicant: MILWAUKEE ELECTRIC TOOL CORPORATION, Brookfield, WI (US)

(72) Inventors: Stacy D. Rogers, Racine, WI (US); Jason J. Berndt, Shorewood, WI (US); Bradley Van Wagoner, Germantown, WI (US); Jonathan S. Pinske, Pewaukee, WI (US); Matthew D. Strommen, Greendale, WI (US)

(21) Appl. No.: 19/544,033

(22) Filed: Feb. 19, 2026

Related U.S. Application Data
(60) Provisional application No. 63/761,251, filed on Feb. 21, 2025.

(51) Int. Cl. A41D 19/015; F21V 33/00; H05B 3/34

(52) U.S. Cl. CPC A41D 19/01535; F21V 33/0008; H05B 3/342; H05B 2203/036

(57) ABSTRACT

A heated hand garment configured to be worn by a user includes a body defining an interior configured to receive a hand of the user and including a first side and a second side opposite the first side, a heating element supported by the body, and a battery receiving receptacle positioned on the second side of the body and in electrical communication with the heating element. The battery receiving receptacle is configured to receive a battery pack. The heated hand garment further includes an actuator positioned on the first side of the body and in electrical communication with the heating element. The actuator is selectively operable to control the heating element.

### CROSS-REFERENCE TO RELATED APPLICATIONS

This application claims priority to U.S. Provisional Patent Application No. 63/761,251, filed February 21, 2025, the entire contents of which are incorporated herein by reference.

### FIELD

The present disclosure relates to a heated hand garment. More particularly, the present disclosure relates to a glove or mitten including a heating element for warming a hand of a user.

### SUMMARY

One aspect of the present disclosure relates to a heated hand garment configured to be worn by a user, the heated hand garment including a body defining an interior configured to receive a hand of the user and including a first side and a second side opposite the first side; a heating element supported by the body; a battery receiving receptacle positioned on the second side of the body and in electrical communication with the heating element, the battery receiving receptacle configured to receive a battery pack; and an actuator positioned on the first side of the body and in electrical communication with the heating element, the actuator selectively operable to control the heating element.

In some aspects, the present disclosure relates to a heated garment configured to be worn by a user, the heated garment including a body configured to be worn by the user; a heating element supported by the body; and an actuator supported by the body and in electrical communication with the heating element, the actuator selectively operable to control the heating element and including an interface having a plurality of light sources, each light source corresponding to a heat setting of the heating element, and a plurality of light guides, each light guide sized and shaped to receive one of the plurality of light sources and configured to block light from one light source from being shown in an adjacent light guide.

In some aspects, the present disclosure relates to a heated hand garment configured to be worn by a user, the heated hand garment including a body defining an interior configured to receive a hand of the user and including a palm portion and a finger portion extending away from the palm portion; a heating element supported by the body, the heating element including a first segment and a second segment, extending in a first direction, and having a first thickness, and a third segment connecting the first segment to the second segment, extending in a second direction different than the first direction, and having a second thickness that is less than the first thickness, wherein, under a common energy input to the first segment, the second segment, and the third segment, a greater amount of heat is generated in the third segment than in the first segment or the second segment.

Other independent aspects of the disclosure will become apparent by consideration of the detailed description and accompanying drawings.

### BRIEF DESCRIPTION OF THE DRAWINGS

FIG. 1A is a front plan view of a heated hand garment.

FIG. 1B is a rear plan view of the heated hand garment of FIG. 1.

FIG. 2 is a rear plan view of part of the heated hand garment of FIG. 1A.

FIG. 3A is a plan view of an actuator for use with the heated hand garment of FIG. 1, the actuator indicating a HIGH heat setting.

FIG. 3B is a plan view of the actuator of FIG. 3A, the actuator indicating a MEDIUM heat setting.

FIG. 3C is a plan view of the actuator of FIG. 3A, the actuator indicating a LOW heat setting.

FIG. 4A is a front plan view of the actuator of FIG. 3A.

FIG. 4B is a rear perspective view of the actuator of FIG. 3A.

FIG. 5 is a block diagram of the heated hand garment of FIG. 1.

FIG. 6 is a schematic of the heated hand garment of FIG. 1, illustrating a heating element of the heated hand garment.

FIG. 7A is a thermal schematic of another heating element for use in the heated hand garment of FIG. 1.

FIG. 7B is a thermal schematic of the heating element of FIG. 6.

FIG. 8A is a front plan view of a heated hand garment, according to another embodiment.

FIG. 8B is a rear plan view of the heated hand garment of FIG. 8A.

FIG. 9A is an exploded perspective view of part of a back side of the heated hand garment of FIG. 8A.

FIG. 9B is a perspective view of part of a palm side of the heated hand garment of FIG. 8A.

### DETAILED DESCRIPTION

Before any independent embodiments of the disclosure are explained in detail, it is to be understood that the disclosure is not limited in its application to the details of construction and the arrangement of components set forth in the following description or illustrated in the following drawings. The disclosure is capable of other independent embodiments and of being practiced or of being carried out in various ways.

Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof.

Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed.

Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a ROM (Read Only Memory), a RAM (Random Access Memory), register memory, a processor cache, or any combination thereof.

Many of the modules and logical structures described are capable of being implemented in software executed by a microprocessor or a similar device or of being implemented in hardware using a variety of components including, for example, application specific integrated circuits (“ASICs”). Terms like “controller” and “module” may include or refer to both hardware and/or software. Capitalized terms conform to common practices and help correlate the description with the coding examples, equations, and/or drawings. However, no specific meaning is implied or should be inferred simply due to the use of capitalization. Thus, the claims should not be limited to the specific examples or terminology or to any specific hardware or software implementation or combination of software or hardware.

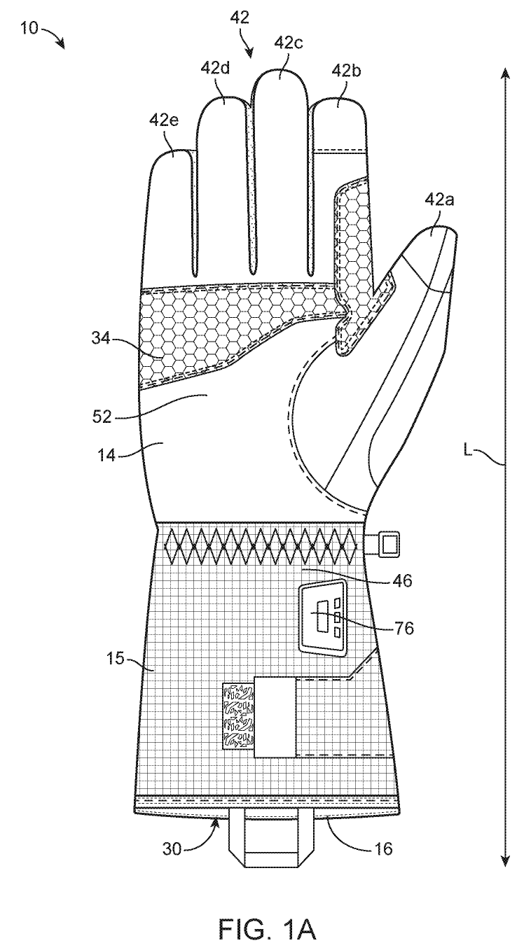

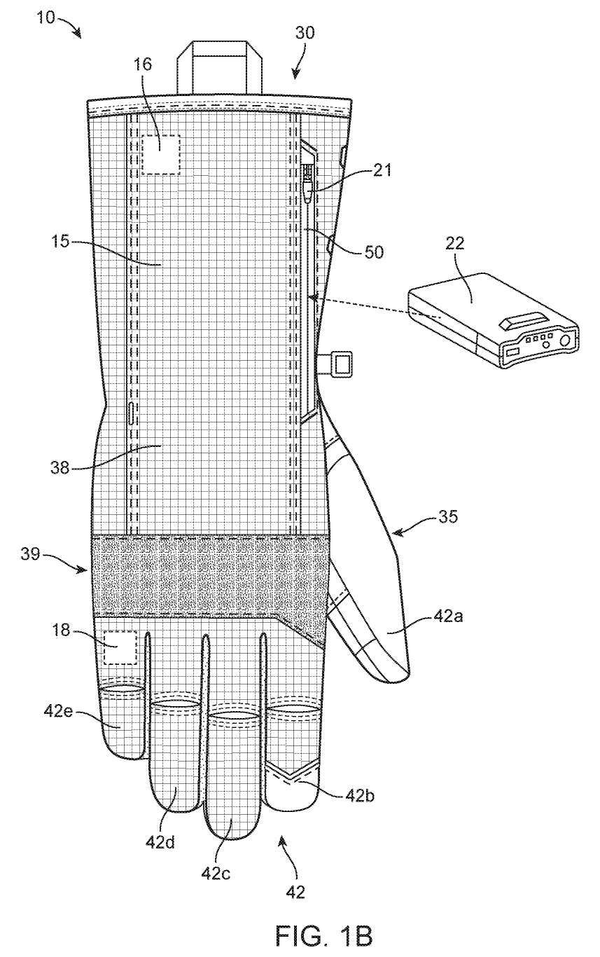

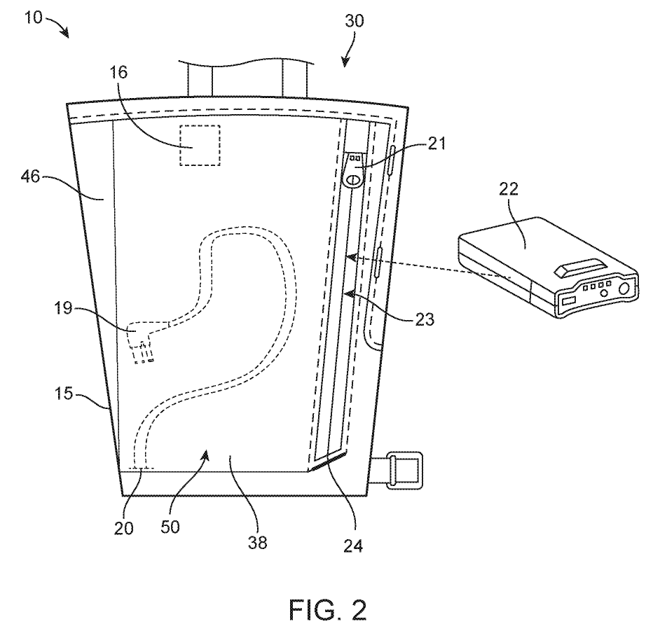

FIGS. 1A-2 illustrate a heated garment, such as, for example, a glove 10, a mitten, a muff, a sock, other clothing or covering, etc., for a user’s extremity (e.g., hand, foot, etc.). A user is to be understood as the wearer of the glove 10. The glove 10 is illustrated as a standalone device, however, the glove 10 may come as a set with a second glove (not shown). The second glove may be identical or may be provided as a mirror image of the glove 10. Thus, it should be understood that each glove 10 in the set is essentially identical, though mirrored for left and right variants, and all description of the glove 10 herein applies to the second glove, which need not be described separately. For example, a heating of the glove 10 may be controlled, and each glove 10 in the set may be controlled independently of the other. In some implementations, the set may be controlled together by a common control system.

As shown in FIGS. 1A-2, the glove 10 includes a body 14 defining an interior 30 of the glove 10 for receiving the user’s hand. The body 14 includes a first side 34 and a second side 38 opposite the first side 34. In the illustrated embodiment, when the glove 10 is worn, the first side 34 is adjacent a palm of the user, and the second side 38 is adjacent the back side of the user’s hand. Accordingly, the first side 34 may be referred to as a palm side 34 of the body 14, and the second side 38 may be referred to as a back side 38 of the body 14.

The illustrated body 14 includes an outer shell 15 and a liner 16. The liner 16 is configured to be received within the outer shell 15 such that the liner 16 is in direct contact with the user’s hand. The liner 16 is preferably formed from a fabric material, such as a woven fabric and/or a knitted fabric and/or any other suitable type of material, allowing the user to move their hand within the glove 10. In contrast, the outer shell 15 is preferably formed from a water-proof material or fabric such as synthetic fabric, waterproof nylon fabric, polyurethane, and/or any other suitable material, thereby protecting the liner 16 and the user’s hand from getting wet. In some embodiments, the glove 10 may further include an inner waterproof membrane (not shown) configured to protect the user’s hand from getting wet. In other embodiments, the body 14 may be made of other layers and/or materials.

With continued reference to FIGS. 1A-2, the body 14 includes one or more digit portions 42 and a wrist portion 46. The digit portions 42 may also be referred to as a finger portion. The digit portions 42 extend outwardly from the wrist portion 46 and are arranged in a substantially linear arrangement for receiving the digit(s) (e.g., fingers or toes) of a user. The illustrated digit portions 42 include a first digit portion 42a configured to receive a thumb of the hand, and second, third, fourth, and fifth digit portions 42b, 42c, 42d, 42e are configured to receive each finger of the hand. In other implementations, the body 14 may define a different number of digit portions 42 suitable for the construction of the garment – e.g., for a mitten, one digit portion for the user’s thumb and a second digit portion for the user’s four fingers, or for a sock one digit portion for all of the user’s toes.

The digit portions 42 extend around the thumb and fingers of the hand from the palm side 34 to the back side 38. In other words, the plurality of digit portions 42 are configured to enclose the fingers and the thumb of the hand received in the glove 10. In other embodiments, one or more of the digit portions 42 may be open, allowing at least a portion of the user’s respective digit(s) to extend through the digit portion and into the environment exterior to the glove 10. The body 14 also includes a third side 35 and a fourth side 39. In general, the third side 35 is adjacent the first digit portion 42a, and the fourth side 39 is adjacent the fifth digit portion 42e. In one example, the first digit portion 42a could be considered the thumb-digit portion, and the fifth digit portion 42e could be considered the pinky-digit portion. Accordingly, the third side 35 may be referred to herein as the thumb side 35 of the body 14, and the fourth side 39 may be referred to as the pinky side 39 of the body 14.

With reference to FIGS. 1B-2, when the glove 10 is worn, the wrist portion 46 is positioned on a wrist of the user. The wrist portion 46 extends around the wrist from the palm side 34 to the back side 38. In other words, the wrist portion 46 is configured to enclose the wrist of the user. The illustrated glove 10 includes a power source receiver, such as a battery receiving receptacle 50, positioned on the wrist portion 46, configured to receive a battery pack 22. The battery receiving receptacle 50 may also be referred to as a pocket.

In the present embodiment, the glove 10 includes a closure member, such as a zipper 21, coupled to the battery receiving receptacle 50 and configured to permit the battery receiving receptacle 50 to be opened and/or closed by the user. More specifically, the battery receiving receptacle 50 includes a closable entrance 23 (e.g., opening at the pocket threshold, etc.) generally formed by two halves of a seam 24, through which the battery pack 22 may be moved.

The zipper 21 extends along the wrist portion 46 and is positioned such that the user may easily zip (e.g., joining the seam to close the pocket, closing the entrance 23, etc.) and unzip (e.g., separate the seam to open the pocket, opening the entrance 23, etc.) the zipper 21, thereby regulating selective access to the battery receiving receptacle 50. In other embodiments, the battery receiving receptacle 50 may include any suitable fastening system, such as hooks, loops, buttons, covers, lids, drawstrings, or other features.

As illustrated in FIG. 2, the battery receiving receptacle 50 is positioned on the back side 38 and the thumb side 35 of the body 14, specifically of the wrist portion 46. In other embodiments, the battery receiving receptacle 50 may be positioned anywhere on the body 14, such as on the palm side 34 and/or pinky side 39 of the wrist portion 46. In one example arrangement of the glove 10, the entrance 23 is positioned on the thumb side 35. In another example arrangement, the entrance 23 could be positioned on another and/or multiple sides of the body 14.

The glove 10 further includes a heating element 18, coupled to and powered by the battery pack 22, that is operable to heat at least a portion of a user’s hand. The battery pack 22 is coupled to the heating element 18 via a battery power cord 19, which extends through an opening 20 of the battery receiving receptacle 50 to be coupled with the battery pack 22. The battery power cord 19 may be any suitable connector configured to enable electrical communication and power distribution between the battery pack 22 and the heating element 18 (e.g., a universal serial bus (USB) connector, a barrel connector, etc.). A garment controller or glove controller 26 (as shown in FIG. 5) may be configured to control the heating of the glove 10 via charging and discharging of the battery pack 22.

In some implementations, the glove 10 may be powered by more than one battery pack 22. In such implementations, the glove 10 may include a receptacle arrangement to accommodate multiple battery packs 22 (e.g., a single receptacle constructed to receive multiple battery packs 22, a separate receptacle 50 for each battery pack 22, etc.). In such constructions, the glove 10 may operate with fewer than the maximum number of battery packs 22 (e.g., a single operational battery pack 22 may power the glove 10 even with other battery pack(s) 22 being missing or disabled). In such constructions, the battery pack 22 is onboard the glove 10. However, in other implementations (not shown), the battery pack 22 or other power source may be remote from the glove 10. For example, the glove 10 may be powered by a battery pack located on another article of clothing (e.g., a jacket, vest, belt, etc.), or any other remote power source. In such constructions, the glove 10 may be connected to the battery pack by, for example, a wire. Although the battery pack 22 is illustrated as being substantially rectangular and generally flat, the battery pack 22 could be another shape and size, such a cylindrical, box-shaped, or the like. In some embodiments, the battery pack 22 includes a stem, while in others, the battery pack 22 includes a slot and a rail. Stated differently, the battery pack 22 may be a stem-type battery pack, a slot-and-rail-type battery pack, or another type of battery pack that may be usable with one or more power tools.

As shown in FIGS. 1A-4B, the glove 10 further includes an actuator 76 (e.g., a button, a switch, a trigger, etc.) engageable by a user to control (e.g., turn ON, turn OFF, and/or select a heating mode or level, etc.) the heating element 18. The actuator 76 is supported on the body 14. In the illustrated embodiment, the actuator 76 is sewn onto the liner 16 and extends through a corresponding opening in the outer shell 15. More particularly, the illustrated actuator 76 includes a lip 77 configured to assist in aligning the actuator 76 within the corresponding opening and sewing the actuator 76 to the liner 16.

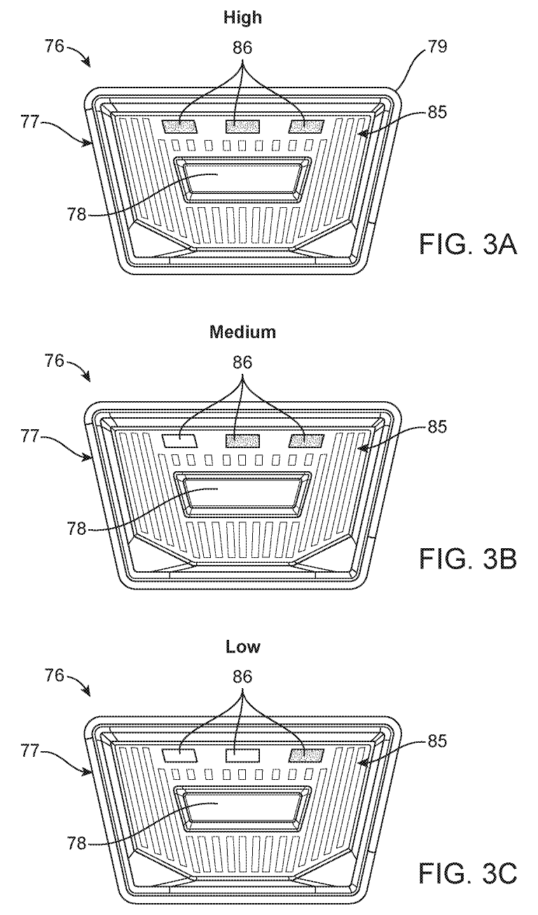

In the present embodiment, the actuator 76 is substantially polygonal in shape and includes chamfered corners 79 (FIG. 3A), forming a generally trapezoidal shape. However, in other embodiments, the actuator 76 may be any suitable shape (e.g., circle, square, etc.). The actuator 76 has a striped texture and includes a raised central bar 78 configured to indicate to the user, based on touch, where the actuator 76 is and where the actuator 76 is engageable. As shown in FIGS. 1A and 1B, the body 14 supports the actuator 76 on the palm side 34 of the wrist portion 46, opposite the battery-receiving receptacle 50. As further illustrated in FIGS. 1A and 1B, the actuator 76 and the battery-receiving receptacle 50 are both positioned on the thumb side 35 of the wrist portion 46. In some embodiments, however, the actuator 76 and the battery-receiving receptacle 50 are positioned on different sides of the wrist portion 46 and/or body 14 more generally.

In one example application of the present disclosure, positioning the actuator 76 on the palm side 34 of the wrist portion 46 provides ease of access to the user. In addition, positioning the actuator 76 opposite the battery receiving receptacle 50 may reduce bulk on one side of the body 14, promote balance, etc.

The actuator 76 may be configured to communicate with the glove controller 26 of the associated glove 10 to switch ON, OFF, and/or between a number of heating settings of the heating element 18, such as HIGH, MEDIUM, and LOW, and corresponding discharge levels of the battery pack 22. Discharge current is configured to run from the battery pack 22 through a circuit 226 (FIG. 5) and to the heating element 18. The heating element 18 then receives electrical energy from the battery pack 22 and converts said electrical energy into heat.

The user may interact with the actuator 76 to control operation of the heating element 18. In some embodiments, when the actuator 76 is first activated, the glove 10 may enter a pre-heat mode. The glove 10 may remain in the pre-heat mode for a predetermined period of time before the heating element 18 switches to the MEDIUM setting. The user may at any point adjust the thermal output setting with the actuator 76.

In the illustrated embodiment, the actuator 76 is a push button for ease of use. The actuator 76 is configured such that subsequent presses of the actuator 76 change the thermal output setting according to a sequence (e.g., HIGH, MEDIUM, LOW then back to HIGH and so on). The actuator 76 is configured to turn the heating element 18 OFF after being pressed and held for a designated period of time (e.g., 1.5 seconds). In other embodiments, the number of thermal output settings, the initial thermal output setting, and the sequence of thermal output settings may vary. Stated differently, successive operation of the actuator 76 cycles through the thermal output setting (e.g., heat setting).

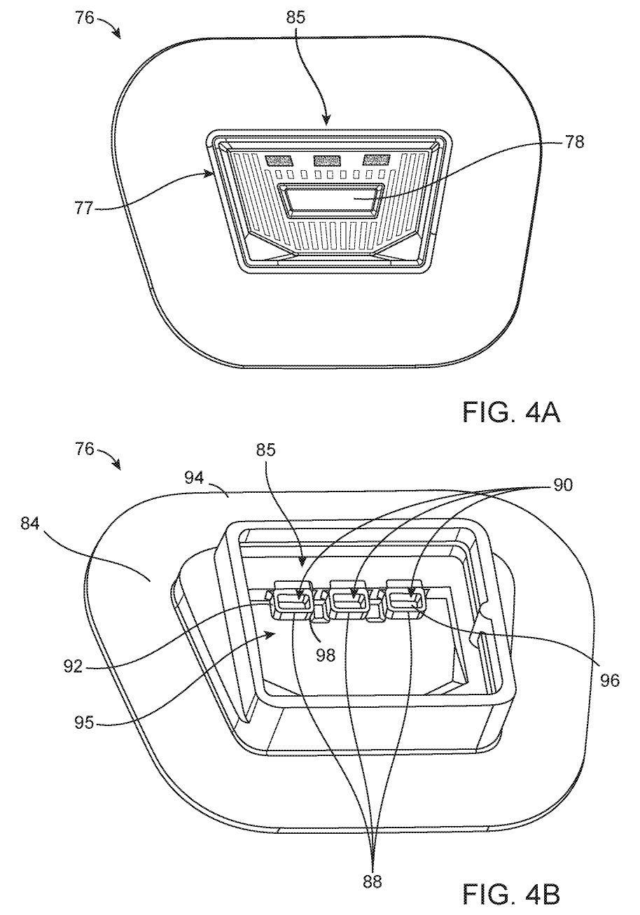

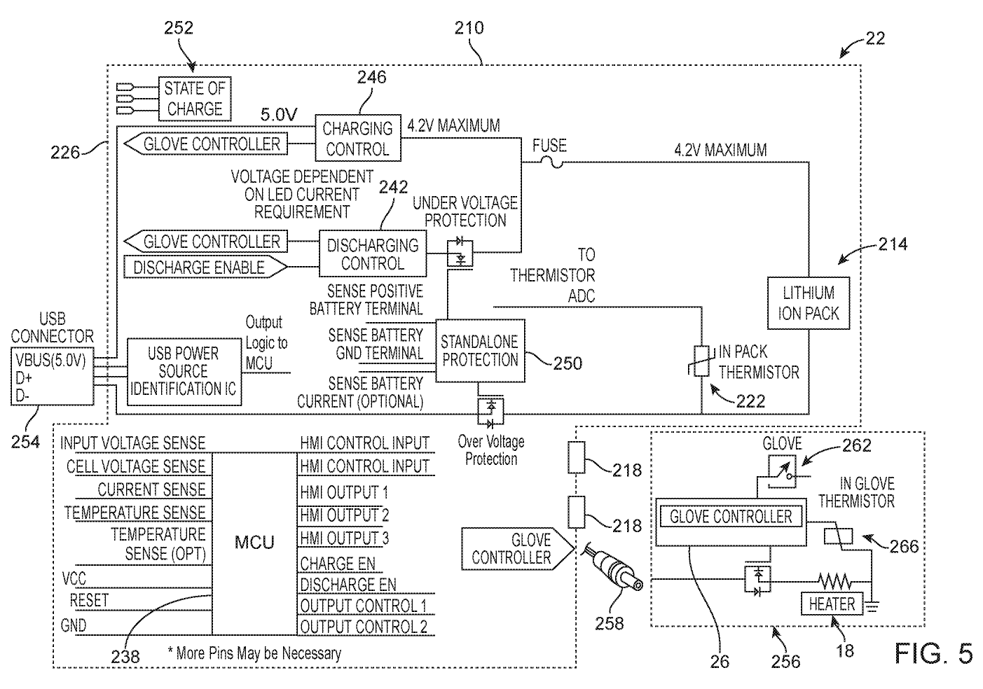

As shown in FIGS. 3A-4B, the actuator 76 includes a base 84 and an interface 85 supported on the base 84. In some embodiments, the interface 85 is substantially polygonal. In the present embodiment, the interface 85 is substantial trapezoidal. The interface 85 includes a plurality of light sources, such as bulbs or LEDs 86, configured to indicate which heating setting is active. In the illustrated embodiment, the interface 85 includes three (3) LEDs 86. The interface 85 is positioned adjacent the raised central bar 78 but separated enough therefrom that the user may see the interface 85 while toggling the heating settings (e.g., when pressing the raised central bar 78). As best illustrated in FIG. 1A, the LEDs are arranged vertically along a length L of the arm of the user. That is, the LEDs are arranged in a line that extends along the length L of the arm of the user. However, in other embodiments, the LEDs 86 may be arranged horizontally.

The LEDs 86 are configured such that when the heating element 18 is in the LOW mode, one LED 86 is illuminated (FIG. 3A). When the heating element 18 is in the MEDIUM mode, two LEDs 86 are illuminated (FIG. 3B). Finally, when the heating element 18 is in the HIGH mode, all three LEDs 86 are illuminated (FIG. 3C). While three LEDs 86 are contemplated in the present embodiment, any appropriate number of LEDs 86 may be implemented into the actuator 76. Like above, successive operation of the actuator 76 also alters a number of illuminated LEDs 86.

As best illustrated in FIG. 4B, the actuator 76 further includes a plurality of light guides 88 sized and shaped to receive each of the plurality of LEDs 86, respectively. In other words, each light guide 88 receives one of the LEDs 86. In other instances, however, multiple light sources (e.g., LEDs 86) may be received in a single light guide 88, as long as the light sources in each light guide 88 correspond to a single heat setting.

The light guides 88 include recesses 90 configured to reduce unwanted “light bleed” of the LEDs 86. For example, each light guide 88 blocks light from one LED 86 from being shown in a light guide 88 of an adjacent LED 86 by fully seating the LED 86 within the corresponding recess 90. In other words, the light guides 88 allow the user to clearly see which of the LEDs 86 is illuminated and not illuminated. In the illustrated embodiment, the recesses 90 are defined by raised sidewalls 92 formed on an underside 94 of the actuator 76, and the sidewalls 92 are substantially opaque. In one instance, light bleed is inhibited primarily because the sidewalls 92 extend far enough away from the base 84 to block light from the LEDs 86 from escaping to an adjacent light guide 88. Further, the light guides 88 are positioned within an internal cavity 95 of the actuator 76, which is sized and shaped to fit electrical components, such as the LEDs 86 and those described in detail below.

As further illustrated in FIG. 4B, The illustrated sidewalls 92 are integrally formed with the rest of the actuator 76, but may alternatively be separate pieces that are coupled to the actuator 76. In other embodiments, the light guides 88 may have other configurations. In one example orientation, the sidewalls 92 extend from their base rearwardly from the base 84 by an amount sufficient to receive an LED 86 or light assembly. The LED 86 may be secured in the light guide 88 through contact with the sidewalls 92, such as through a snap-fit, welding, adhering, fastening, and/or the like. Accordingly, in some embodiments, the sidewalls 92 are made of metal or a metal composite, while in other embodiments the sidewalls 92 are made of plastic. In one example construction, the sidewalls 92 are extruded from the base 84. In another example construction, the sidewalls 92 are pre-formed and later coupled to the base 84. In yet another example construction, the sidewalls 92 and recesses 90 are milled from the base 84 (e.g., subtractive manufacturing).

It should be appreciated that regardless of construction technique, each light guide 88 is configured to be positioned to allow light from its respective LED 86 to show through an opening/window 96 extending through the actuator 76 (e.g., to an observer-side of the interface 85). In some instances, the LED 86 in each light guide 88 is positioned close to the window 96 to minimize a depth for each side wall 92. In other instances, the window 96 is omitted. Further, in some embodiments, the light guides 88 include a seal 98 applied in and/or around the recesses 90 and/or sidewalls 88 to further block light bleed and/or seal the light guide 88 to the interface 85. In some instances, the light guides 88 may be assembled together remotely and then attached to the base 84, either as single light guides 88 or as an assembly of multiple light guides 88. Similairiy, the light guides 88 may be coupled to the base 84 before or after the LEDs 86 are positioned and secured in the recesses 90.

As schematically illustrated in FIG. 5, the battery pack 22 includes a pack housing 210 supporting one or more battery cells 214. Each of the illustrated battery cells 214 is a lithium-ion battery cell having a nominal voltage of about 3.6 V to about 4.4 V (e.g., about 4.2 V) and a capacity of between about 2.0 Amp-hours (Ah) and 5.0 Ah (e.g., about 3.0 Ah). For example, the battery pack 22 may be a 12 V Li-ion battery pack, such as the Heated Gear Power Source sold by Milwaukee Electric Tool Corporation. In other constructions, the nominal voltage of the battery pack 22 may be varied to meet the requirement of specific applications. In other constructions, the battery cell(s) may have a different chemistry, nominal voltage, capacity, etc., and/or the battery pack 22 may have a different configuration.

Pack terminals 218, or ports, are supported on the housing 210 to electrically connect the cell(s) 214 to an electrical device, such as the glove 10, a battery charger, etc., for power transfer (e.g., a charge/discharge terminal and a ground terminal) and/or for communication. The battery pack 22 includes a temperature sensor (e.g., a thermistor 222) operable to sense a temperature of the battery pack 22 and/or of the cell(s) 214, and one of the terminals 218 is a communication terminal operable to communicate at least the sensed temperature to the electrical device.

FIG. 5 also schematically illustrates a circuit 226 of the battery pack 22. At least a portion of the circuit 226 is supported by the housing 210. The circuit 226 includes a master controller 238 including at least a memory configured to store software-based instructions and an electronic processor configured to execute the software. The controller 238 may, for example, be configured to, in addition to monitoring characteristics of the battery pack 22 (e.g., battery pack temperature (via electrical coupling with a thermistor), current, cell voltage, state of charge, etc.) and/or of the external power source (e.g., input voltage, current, etc.), etc., control charging and discharging protocols for the battery pack 22, identify when the circuit 226 is connected to the glove 10, and apply protection protocols for the battery pack 22/circuit 226.

The illustrated circuit 226 includes a discharging control 242 operated by the controller 238 to discharge the battery pack 22 and a charging control 246 operated by the controller 238 to charge the battery pack 22. In some constructions, the controller 238 may prevent simultaneous charging and discharging of battery pack 22. Protection circuitry 250 is operated by the controller 238 to perform protection protocols which may include terminating charging or discharging of the battery pack 22 based on monitored characteristics (e.g., pack temperature reaching a temperature threshold value, cell voltage reaching a voltage threshold value, etc.). The protection protocols may include protecting against short circuits in the electrical wiring, cables, etc., of the glove 10.

In addition, the controller 238 may be configured to activate one or more indicators 252 (e.g., LEDs, etc.) to indicate an operational state of the battery pack 22 (e.g., a charge level), of the circuit 226 (e.g., whether charging is occurring), of the glove 10 (e.g., whether heating is occurring, a selected heating mode, etc.), etc. The controller 238 may be configured to store software-based instructions and an electronic processor may be configured to execute the software to accomplish one or more of the functions described above (e.g., charging/discharging control, protection, etc.).

As illustrated, external power is provided to the circuit 226 through the power inlet 254 (e.g., a USB-C connector) to provide charging current to charge the battery pack 22 via the charging control 246.

A glove circuit portion 256 may be connected to the circuit 226 by a connector plug 258. The glove circuit portion 256 includes the heating element 18 and the glove controller 26. The glove controller 26 may include a memory configured to store software-based instructions and an electronic processor configured to execute the software. The glove controller 26 may, for example, be configured to control operation of the heating element 18, to monitor characteristics of the glove 10 (e.g., temperature, etc.), etc. The glove circuit portion 256 may further incorporate a thermistor 266 connected to sense changes in a glove contact 262 and/or additional sensor.

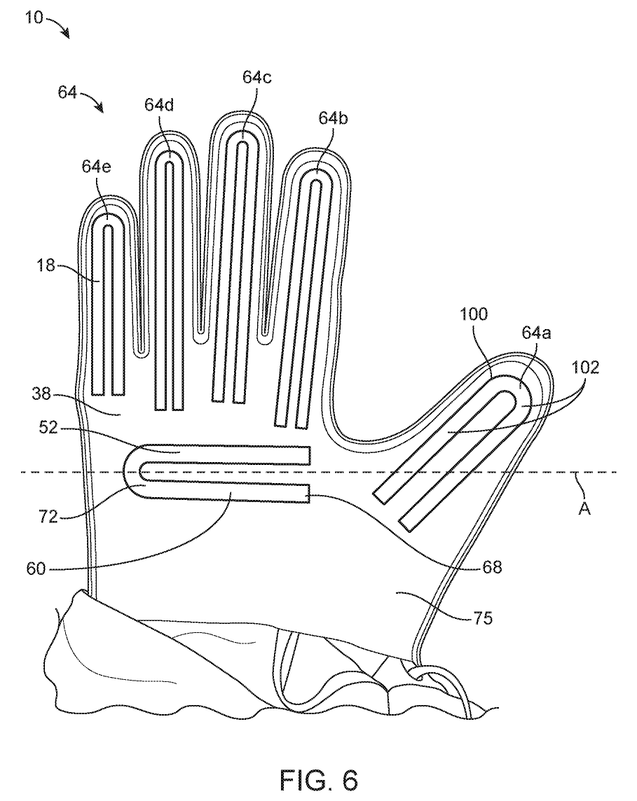

With reference to FIG. 6, the heating element 18 includes a material 75 including fibers operable to conduct heat. The illustrated heating element 18 includes a metallic fiber material 75 having a base such as carbon fiber, aluminum, stainless steel, etc. In addition, the heating element 18 can have different power ratings. For example, the power of the illustrated heating element 18 is 5.5 Watts. In other embodiments, the power of the heating element 18 is 7.4 Watts.

The illustrated heating element 18 further includes a central portion 60 and a plurality of finger portions 64 to form a heating element pattern. The central portion 60 is positioned on the back side 38 of the wrist portion 46. The central portion 60 includes a first end 68 and a second end 72. The central portion 60 is substantially U-shaped such that a U extends from the first end 68 to the second end 72 along a longitudinal axis A. The central portion 60 is configured to heat (i.e., warm) the user’s hand on the back side 38. In other embodiments, the central portion 60 may have other configurations (e.g., shapes) or may be omitted.

The finger portions 64 extend orthogonal to the longitudinal axis A of the central portion 60. The finger portions 64 are configured to correspond to the number of digit portions 42 of the body 14. For example, the illustrated finger portions 64 include a first, second, third, fourth, and fifth finger portions 64a, 64b, 64c, 64d, 64e corresponding to the first, second, third, fourth, and fifth digit portions 42a, 42b, 42c, 42d, 42e. In other embodiments, the finger portions 64 may include a first finger portion and at least a second finger portion. For example, the finger portions 64 may include a first finger portion configured to heat the thumb of the hand and a second finger portion configured to heat all of the fingers if, for example, the hand garment is a mitten. The finger portions 64 are configured to heat (i.e., warm) the fingers received in the digit portions 42 of the glove 10 on the back side 38.

In the present embodiment, the finger portions 64 are not connected to one another. However, in other embodiments, the finger portions 64 may be connected such that the finger portions 64 form one uninterrupted piece. For example, in some embodiments, the finger portions 64 may be connected to the central portion 60 to connect the finger portions 64 and the central portion 60 together. In other embodiments, the finger portions 64 may be directly coupled together.

Each of the finger portions 64 are substantially U-shaped, such that each finger portion 64 follows the contour, or perimeter, of each of the user’s fingers. More particularly, each finger portion 64 includes a bend segment 100 and two straight-line segments 102. The bend segment 100 is located at the distal end of a corresponding digit portion 42a, 42b, 42c, 42d, 42e, opposite from the central portion 60 and the palm portion 52. The bend segment 100 is disposed between, and connects, the two straight-line segments 102 to create the above described U-shape. Each of the bend segment 100 and the straight-line segments 102 has a thickness.

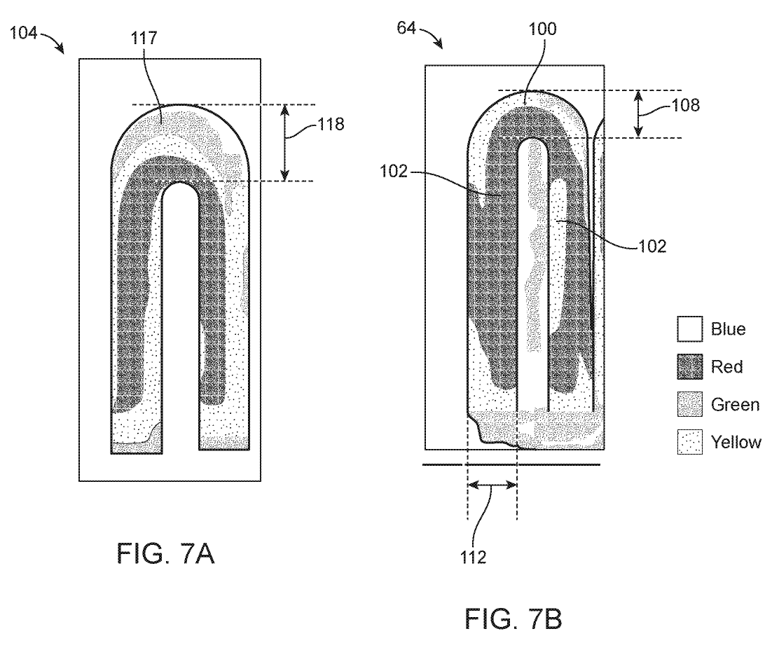

In the illustrated embodiment, a thickness 108 of the bend segment 100 is thinner than (or less than) a thickness 112 of the two straight-line segments 102 (FIG. 7B). For example, in some embodiments, the thickness 108 of the bend segment 100 may be at least 5% less than the thickness 112 of the straight-line segments 102. In other embodiments, the thickness 108 of the bend segment 100 may be at least 10% less than the thickness 112 of the straight-line segments 102. In the illustrated embodiment, the thickness 108 of the bend segment 100 is about 15% less than the thickness 112 of the straight-line segments 102. In one example application of the present disclosure, decreasing the thickness 108 of the bend segment 100 decreases an area through which electrical energy from the battery pack 22 can or must travel. As such, the resistance at the bend segments 100 is increased, thereby increasing heat generated at the bend segments 100 and tips of the user’s digits. In other words, making the bend segment 100 thinner while maintaining a consistent electrical current (i.e., a common energy input) increases resistance per square inch within the finger portions 64, thus increases heat generated.

FIG. 7A illustrates an image taken by a thermal camera of a differently shaped finger portion 104 in a temperature-controlled environment. In the configuration illustrated in FIG. 7A, the finger portion 104 includes a bend segment 117 having a thickness that is equal to or greater than a thickness of straight-line segments. FIG. 7B illustrates an image taken by a thermal camera of one of the finger portions 64 of the present embodiment in a temperature-controlled environment. As shown, the bend segment 100 in FIG. 7B, which relates to a position of the user’s fingertip, is significantly warmer than the differently shaped finger portion 104 in FIG. 7A, which has the thicker bend segment 117 than that of the finger portions 64. As shown, the thickness 108 of the bend segment 100 is smaller than a thickness 118 of the bend segment 117 of the differently shaped finger portion 104 and, as a result, the bend segment 100 of the present embodiment produces more heat than the thicker bend segment 117.

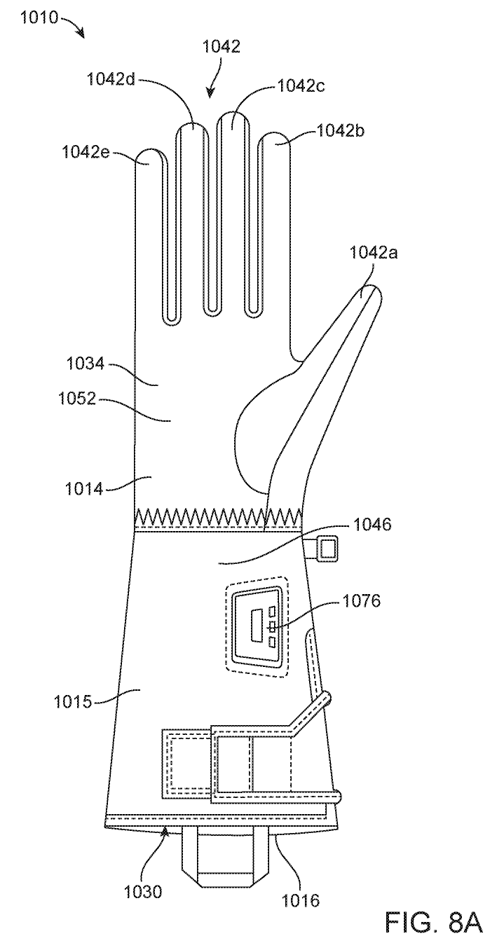

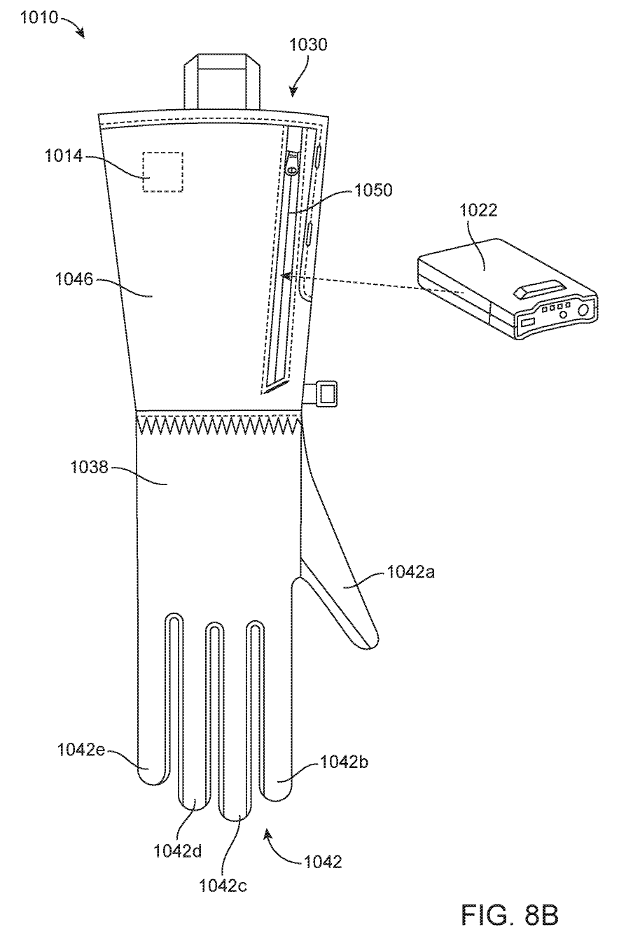

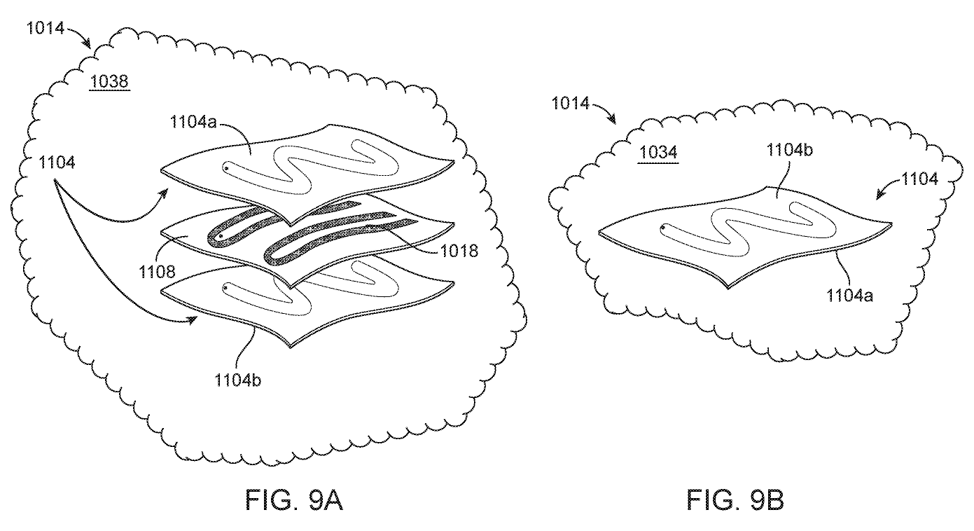

FIGS. 8A-9B illustrate a heated garment according to another embodiment of the disclosure. In the illustrated embodiment the heated garment is a glove 1010. The glove 1010 is like the glove 10 shown in FIGS. 1-7B and described above. Therefore, like features are identified with like reference numerals plus “1000”, and only the differences between the two will be discussed.

The glove 1010 includes a body 1014 defining an interior 1030 of the glove 1010 for receiving the user’s hand. The glove 1010 is configured to be worn by the user underneath another glove or mitten, such as a non-heated glove or mitten. Accordingly, the glove 1010 may be understood as a heated glove liner. The body 14 includes a first side 1034 and a second side 1038 opposite the first side 1034. In the illustrated embodiment, when the glove 1010 is worn, the first side 1034 is adjacent a palm of the user, and the second side 1038 is adjacent the back side of the user’s hand. Accordingly, the first side 1034 may be referred to as a palm side 1034 of the body 1014, and the second side 1038 may be referred to as a back side 1038 of the body 1014.

The body 1014 includes one or more digit portions 1042a-e (or finger portions) and a wrist portion 1046. The wrist portion 1046 extends around the wrist from the palm side 1034 to the back side 1038. The illustrated wrist portion 1046 includes a battery receiving receptacle 1050 configured to receive a battery pack 1022. The glove 1010 further includes an actuator 1076 (e.g., a button, a switch, a trigger, etc.) engageable by a user to control (e.g., turn ON, turn OFF, and/or select a heating mode or level, etc.) the heating element 1018. The actuator 1076 is supported on the palm side 1034 of the wrist portion 1046. The actuator 1076 may have the same configuration and features as the actuator 76 described above with reference to FIGS. 3A-4B.

With reference to FIGS. 9A and 9B, the illustrated body 1014 includes a two-layer shell 1104 and a heat pad layer 1108. The heat pad layer 1108 includes a heating element 1018 operable to heat at least a portion of a user’s hand. The heating element 1018 may have the same configuration and features as the heating element 18 described above with reference to FIG. 6 and 7B. The heat pad layer 1108 is configured to be received within the two-layer shell 1104 such that the heat pad layer 1108 is surrounded by the two-layer shell 1104. Accordingly, a first layer 1104a of the two-layer shell 1104 is in direct contact with the user’s hand and the heat pad layer 1108, and a second layer 1104b of the two-layer shell 1104 is in direct contact with the heat pad layer 1108 and outwardly facing toward the environment.

In the present embodiment, the heat pad layer 1108 only extends along the back side 1038 of the body 1014 and does not extend along the palm side 1034 of the body 1014. In such instances, the first layer 1104a may face outwardly from the user’s hand and the second layer 1104b may face inwardly toward and/or contacting skin of the user’s hand.

In other embodiments, the heat pad layer 1108 may instead extend along the palm side 1034. In such instances, the first layer 1104a may face inwardly toward and/or contacting skin of the user’s hand and the second layer 1104b may face outwardly from the user’s hand.

In yet other embodiments, the heat pad layer 1108 may instead extend along both the back side 1038 and the palm side 1034. The two-layer shell 1104 is preferably formed from a fabric material, such as stretchable or non-stretchable fleece, polyester, wool, and/or any other suitable type of material, allowing the user to move their hand within the glove 1010. In contrast, the heat pad layer 1108 may be formed from any material suitable to accommodate the heating element 1018.

Thus, the disclosure may provide, among other things, a hand garment, such as a glove 10, and a heating element 18 coupled to the glove 10 for warming a hand of the user. The glove 10 may include the heating element 18 having a heating element pattern, a battery receiving receptacle, a power source such as a battery pack 22, and an actuator 76 for controlling the heating settings.

Although the disclosure has been described in detail with reference to certain preferred embodiments, variations and modifications exist within the scope and spirit of one or more independent aspects of the invention as described.

Various features of the present disclosure are set forth in the following claims.

What is claimed is:

1. A heated hand garment configured to be worn by a user, the heated hand garment comprising:
a body defining an interior configured to receive a hand of the user and including a first side and a second side opposite the first side;
a heating element supported by the body;
a battery receiving receptacle positioned on the second side of the body and in electrical communication with the heating element, the battery receiving receptacle configured to receive a battery pack; and
an actuator positioned on the first side of the body and in electrical communication with the heating element, the actuator selectively operable to control the heating element.

2. The heated hand garment of claim 1, wherein, when the heated hand garment is worn by the user, the first side is configured to be adjacent a palm of the hand and the second side is configured to be adjacent a back side of the hand.

3. The heated hand garment of claim 2, wherein the body includes a third side between the first side and the second side, and wherein, when the heated hand garment is worn by the user, the third side is positioned to be adjacent a thumb of the hand.

4. The heated hand garment of claim 3, wherein the battery receiving receptacle includes a closable entrance adjacent the third side.

5. The heated hand garment of claim 4, wherein the closable entrance is also positioned on the second side.

6. The heated hand garment of claim 4, wherein the actuator is adjacent the third side.

7. The heated hand garment of claim 3, wherein the body includes a wrist portion, wherein, when the heated hand garment is worn by the user, the wrist portion is configured to be adjacent a wrist of the hand, and wherein the actuator is adjacent the third side and positioned on the wrist portion.

8. The heated hand garment of claim 7, wherein the actuator includes a plurality of light sources, each light source corresponding to a heat setting of the heating element, and wherein successive operation of the actuator cycles through the heat settings.

9. The heated hand garment of claim 1, further comprising a connector positioned within the battery receiving receptacle and extending through a portion of the body, wherein the connector is configured to be coupled with a power source, and wherein the power source includes the battery pack or a remote power source.

10. A heated garment configured to be worn by a user, the heated garment comprising:
a body configured to be worn by the user;
a heating element supported by the body; and
an actuator supported by the body and in electrical communication with the heating element, the actuator selectively operable to control the heating element and including
an interface having a plurality of light sources, each light source corresponding to a heat setting of the heating element, and
a plurality of light guides, each light guide sized and shaped to receive one of the plurality of light sources and configured to block light from one light source from being shown in an adjacent light guide.

11. The heated garment of claim 10, wherein the actuator further includes a base and an internal cavity positioned within the base, and wherein the plurality of light guides includes recesses positioned within the internal cavity.

12. The heated garment of claim 11, wherein the recesses are defined by sidewalls extending away from the base and into the internal cavity.

13. The heated garment of claim 12, wherein each light guide of the plurality of light guides is substantially polygonal.

14. The heated garment of claim 12,
wherein each light source of the plurality of light sources is an LED,
wherein the plurality of light guides includes three light guides, each configured to receive one of the LEDs, and
wherein each LED is coupled to a respective light guide at the base of a respective sidewall.

15. A heated hand garment configured to be worn by a user, the heated hand garment comprising:
a body defining an interior configured to receive a hand of the user and including a palm portion and a finger portion extending away from the palm portion; and
a heating element supported by the body, the heating element including
a first segment and a second segment, extending in a first direction, and having a first thickness, and
a third segment connecting the first segment to the second segment, extending in a second direction different than the first direction, and having a second thickness that is less than the first thickness,
wherein, under a common energy input to the first segment, the second segment, and the third segment, a greater amount of heat is generated in the third segment than in the first segment or the second segment.

16. The heated hand garment of claim 15, wherein the third segment is positioned at a tip of the finger portion.

17. The heated hand garment of claim 15, wherein the first segment, the second segment, and the third segment are positioned in the palm portion.

18. The heated hand garment of claim 15, wherein the heating element is a first heating element positioned in the finger portion, and wherein the heated hand garment further comprises a second heating element positioned in the palm portion.

19. The heated hand garment of claim 15, wherein the heating element is substantially U-shaped.

20. The heated hand garment of claim 15, wherein the second thickness is less than the first thickness by 15% or less.
